(19) United States
(12) Patent Application Publication
(10) Pub. No.: US 2017/0068927 A1
(43) Pub. Date: Mar. 9, 2017

(54) WAREHOUSE PROFIT SIMULATION DEVICE

(71) Applicant: HITACHI, LTD., Tokyo (JP)

(72) Inventors: Hisaya ISHIBASHI, Tokyo (JP); Satoshi NAGAHARA, Tokyo (JP)

(73) Assignee: HITACHI, LTD., Tokyo (JP)

(21) Appl. No.: 15/122,509

(22) PCT Filed: Mar. 26, 2014
(86) PCT No.: PCT/JP2014/058399

§ 371 Date: Aug. 30, 2016

(51) Int. Cl. G06Q 10/08; G06Q 10/06

(52) U.S. Cl. CPC G06Q 10/087; G06Q 10/0637

(57) ABSTRACT

The present invention is to forecast change management and impact with respect to contract conditions when making a distribution warehouse estimate, and improve precision in the estimation thereof. Provided is a warehouse profit simulation device, comprising: an information storage unit which stores data relating to income and outlay in each phase from estimation to operation of a distribution warehouse as historical data in a unitary manner; a profit description deviation analysis unit which reads out the historical data from the information storage unit, carries out a factor diagnosis of the deviation between the estimated amount and the outlays thereafter, and specifies a description of the deviation thereof; a contract condition change scenario registration unit which creates a contract condition change scenario, and registers same in the information storage unit; and a profit calculation simulation execution unit which executes a distribution warehouse profit calculation simulation.

### TECHNICAL FIELD

The present invention relates to a warehouse profit simulation technique.

### BACKGROUND ART

For the purpose of receiving an order for distribution warehouse operations, an estimation proposal about warehouse-related operations is prepared for a customer. Japanese Patent Application Laid-Open No. 2006-31360 (Patent Literature 1) is known as background art relating to a design estimation for a manufacturing line. This application publication describes, “A counter measure diagnosis unit 12 is included that chooses from a countermeasure information storage unit 15 at least one facility which attains a production capacity and/or an invested cost necessary for a simulation result to come close to a target production capacity and a target invested cost, and that outputs the facility to a production simulation unit, wherein a simulation is again executed on the facility chosen by the countermeasure diagnosis unit 12, so that a facility can automatically be chosen which makes the production capacity and the invested cost optimum to plans for the production line.”

### CITATION LIST

### Patent Literature

Patent Literature 1: Japanese Patent Application Laid-Open No. 2006-31360

### SUMMARY OF THE INVENTION

### Technical Problem

The Patent Literature 1 is satisfactorily applicable also to the design for a distribution warehouse if a choice of an optimum base and an accurate estimation of warehousing and delivery operations are possible when an estimation proposal is prepared.

However, when the estimation proposal is prepared, it is difficult to choose an optimum base and to accurately estimate warehousing and delivery operations in a short period of time. The operation starting up of the warehousing and delivery operations does not proceed as scheduled, which results in a mismatch between the unit price setting at the time the contract is made and the actual price setting due to a cost incurred beyond expectation, so that it is often the case that the management falls into deficit.

An object of the present invention is to improve the accuracy of an estimation by forecasting change management of contract conditions at the time of the estimation and the resulting influences.

### Solution To The Problem

The present application includes a plurality of solutions for solving the aforementioned problem and can take its one example as described hereafter.

A warehouse profit simulation device comprising in feature an information storage unit for storing data relating to incomes and expenses in respective phases from estimation to operation of a distribution warehouse as historical data in a unitary manner, a profit description deviation diagnosis unit for reading out the historical data from the information storage unit and for diagnosing factors causing a deviation between estimated amounts and the subsequent balance of payment to specify a description of the deviation, a contract condition change scenario registration unit for creating a contract condition change scenario in response to the specified description of the deviation and registering the scenario in the information storage unit, and a profit calculation simulation execution unit for executing a profit calculation simulation of the distribution warehouse under the registered contract condition change scenario.

### Advantageous Effects Of The Invention

According to the present invention, it can be realized to improve the estimation accuracy of the distribution warehouse.

### BRIEF DESCRIPTION OF THE DRAWINGS:

FIG. 1 is a schematic view of a warehouse profit simulation device.

FIG. 2 is a data table of a warehouse proceeds information storage unit.

FIG. 3 is a data table of a warehouse cost information storage unit.

FIG. 4 is a data table of a contract condition change information storage unit.

FIG. 5 is a data table of a simulation result storage unit.

FIG. 6 is a block diagram showing the hardware structure of the warehouse profit simulation device.

FIG. 7 is a flowchart for a warehouse profit simulation.

FIG. 8 is a flowchart showing a processing executed by a distribution warehouse profitability evaluation unit.

FIG. 9 is an illustration showing a profit estimation screen.

FIG. 10 is an illustration showing another profit estimation screen.

FIG. 11 is an illustration showing another profit estimation screen.

FIG. 12 is a contract condition change screen.

FIG. 13 is an output screen showing the results of a contract condition change simulation.

### DESCRIPTION OF EMBODIMENTS

Hereinafter, one embodiment of the present invention will be described.

### Embodiment 1

### [Basic Construction of Warehouse Profit Simulation Device]

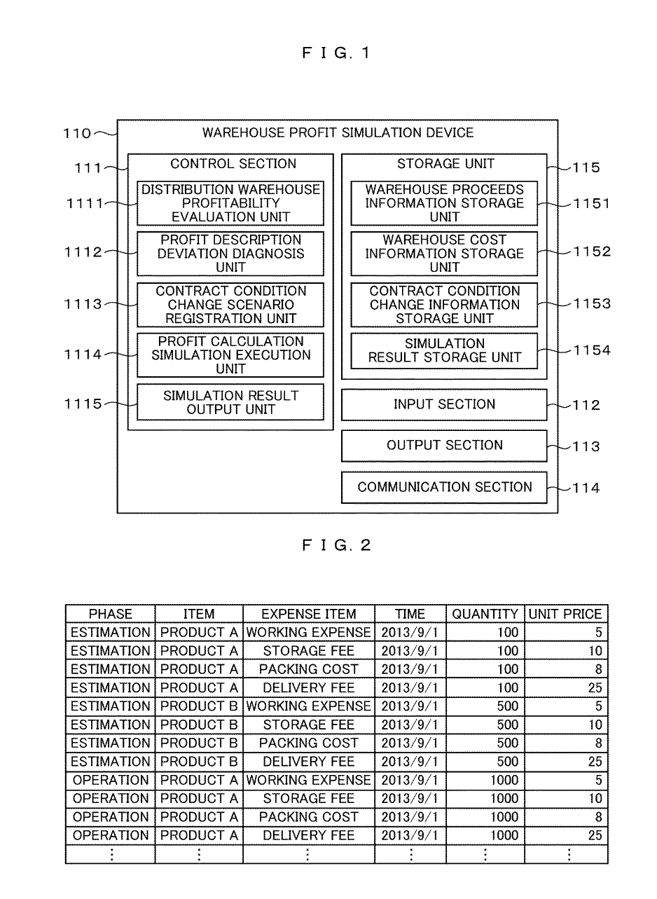

FIG. 1 is a schematic view of a warehouse profit simulation device 110. As shown, the warehouse profit simulation device 110 comprises a control section 111, an input section 112, an output section 113, a communication section 114 and a storage section 115.

The control section 111 comprises a distribution warehouse profitability evaluation unit 1111, a profit description deviation diagnosis unit 1112, a contract condition change scenario registration unit 1113, a profit calculation simulation execution unit 1114, and a simulation result output unit 1115. The input section 112 receives information inputted thereto from the outside. The output section 113 outputs information to the outside. The communication section 114 performs the transmission and reception of information through a network 190. The storage section 115 comprises a warehouse proceeds information storage unit 1151, a warehouse cost information storage unit 1152, a contract condition change information storage unit 1153, and a simulation result storage unit 1154.

[Data formats in Respective Storage Units]

FIG. 2 is a data table of the warehouse proceeds information storage unit 1151. The table is provided with a “Phase” field for registering respective phases (“Estimation”, “Design”, “Operation” and the like) from “Estimation” to “Operation”, an “Item” field for registering “items” of the warehouse proceeds, an “Expense Item” field for registering expense items of the warehouse proceeds, a “Time” field for registering times of the warehouse proceeds, a “Quantity” field for registering the quantity of products which are covered by the warehouse proceeds and are scheduled to be sold at certain times, and a “Unit Price” field for registering unit prices at which the products covered by the warehouse proceeds are scheduled to be sold at the certain times.

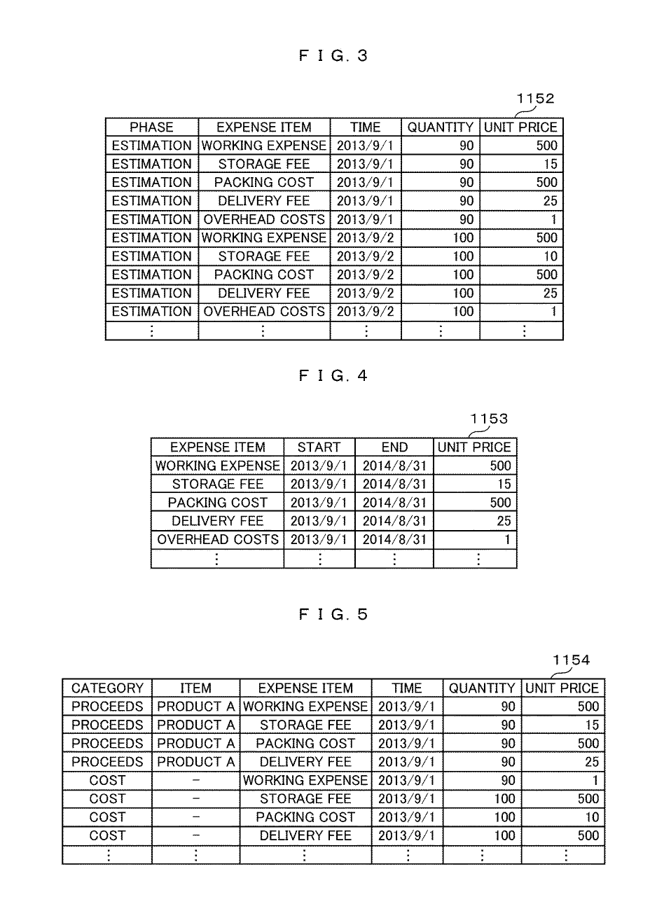

FIG. 3 is a data table of the warehouse cost information storage unit 1152. As shown in FIG. 3, the data table of the warehouse cost information storage unit 1152 is provided with a “Phase” field, an “Expense Item” filed for registering expense items of warehouse costs, a “Time” field for registering times of the warehouse costs, a “Quantity” field for registering sales performance quantities of the products covered by the warehouse costs at certain times, and a “Unit Price” field for registering unit prices at which the products covered by the warehouse proceeds were sold at the certain times.

FIG. 4 is a data table of a contract condition change information storage unit 1153. In FIG. 4, the data table of the contract condition change information storage unit 1153 is provided with an “Expense Item” field for registering expense items under contract conditions, “Start” and “End” fields for respectively registering start and end times of the contract conditions, and a “Unit Price” filed for registering unit prices at which the products covered by the contract conditions are scheduled to be sold at certain times.

FIG. 5 is a data table of a simulation result storage unit 1154. In FIG. 5, the data table of the simulation result storage unit 1154 is provided with a “Category” field for registering categories indicative of “Proceeds” and “Cost” which constitute simulation results, an “Item” for registering items of the warehouse proceeds, an “Expense Item” field for registering expense items (field, warehouse proceeds, costs), a “Time” field for registering times of the warehouse proceeds and the costs, a “Quantity” field for registering the quantity of products covered by the warehouse proceeds and scheduled to be sold at certain times, and a “Unit Price” field for registering unit prices at which products covered by the warehouse proceeds and the costs are scheduled to be sold at certain times.

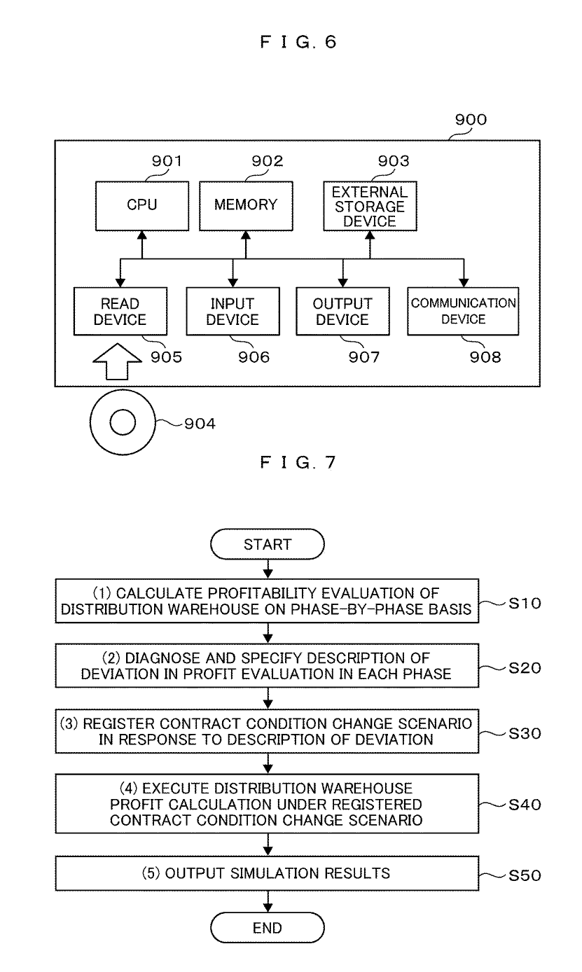

The manufacturing line design device 110 can be realized by a general computer 900 which, as shown in FIG. 6 (a schematic diagram of the computer 900) for example, comprises a CPU (Central Processing Unit) 901, a memory 902, an external storage device 903 such as an HDD (Hard Disc Drive) or the like, a read device 905 for performing the reading and writing of information with a recording medium having portability such as a CD (Compact Disk), a DVD (Digital Versatile Disk) or the like, input devices 906 such as a keyboard, a mouse and the like, output devices 907 such as a display and the like, and a communication device 908 such as an NIC (Network Interface Card) and the like for connection to communication networks.

Next, the processing that the warehouse profit simulation device 110 executes in accordance with a program will be described in order with reference to FIG. 7.

FIG. 7 is a flowchart showing the processing according to which the warehouse profit simulation device 110 in a profit evaluation simulation for a distribution warehouse design work executes data management from estimation to operation in a unitary manner and forecasts change management and the resulting influence therefrom with respect to the contract conditions at the time of the estimation.

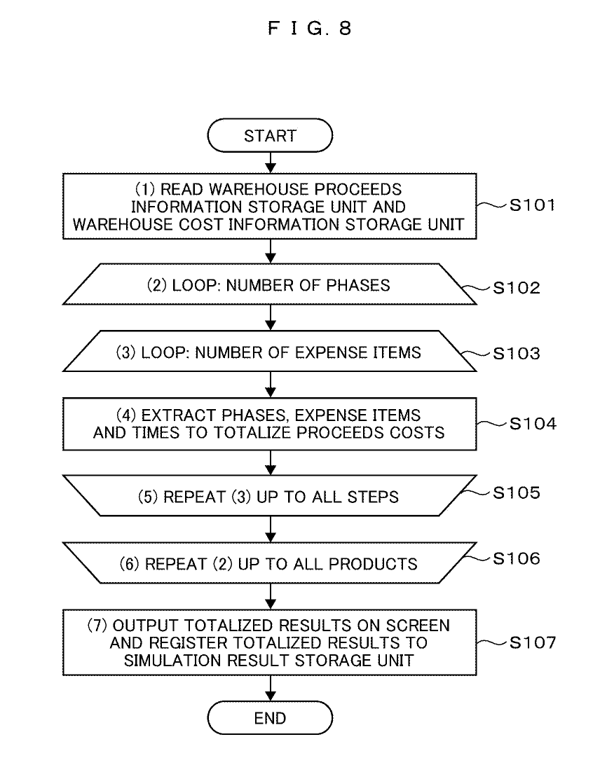

First of all, the distribution warehouse profitability evaluation unit 1111 evaluates the profitability in each phase of a distribution warehouse (S10). The details of this step S10 will be described with reference to FIG. 8. FIG. 8 is a flowchart showing the processing executed by the distribution warehouse profitability evaluation unit 1111 at step S10.

At first, the distribution warehouse profitability evaluation unit 1111 reads data in the warehouse proceeds information storage unit 1151 and data in the warehouse cost information storage unit 1152, which are stored in the storage section 115 (S101).

Then, the distribution warehouse profitability evaluation unit 1111 repeats processing steps S103 to S106 by the number of all of the phases in the warehouse proceeds information storage unit 1152 and the warehouse cost information storage unit 1153 (S102).

Then, the distribution warehouse profitability evaluation unit 1111 repeats processing steps S104 to S105 by the number of all of the expense items in the warehouse proceeds information storage unit 1152 and the warehouse cost information storage unit 1153 (S103).

Then, the distribution warehouse profitability evaluation unit 1111 extracts the phases, the expense items and the times, and totalizes the proceeds costs (S104).

The unit 111 repeats the processing step S104 by the number of all of the expense items (S105) and repeats the processing step S103 to S105 by the number of all of the phases (S106).

Then, the distribution warehouse profitability evaluation unit 1111 outputs the totalized results on a screen in response to an input from the user or automatically and registers the totalized results in the simulation result storage unit 1154 (S107).

FIG. 9 is an illustration showing one example of a profit totalizing screen 1000. In the displayed items 1001, the horizontal axis represents “Time” and the vertical axis represents “Expense”, wherein proceeds and costs totalized on the time basis are shown in the form of a column graph.

The distribution warehouse profitability evaluation unit 1111 receives choices regarding “Phase” and “Totalization Method” from the user. In the example shown in FIG. 9, when the user chooses “Estimation” as “Phase” and chooses “Monthly Totalization” as “Totalization Method” and then depresses a bottom for the input item “Execution” 1003, the distribution warehouse profitability evaluation unit 1111 receives the inputs, executes retotalization on the basis of the inputted “Phase” and “Totalization Method” and executes the display as aforementioned. Although in the example of FIG. 9, the “Estimation” is totalized and displayed on the “Monthly Totalization” basis, it is possible to choose another phase and another “Totalization Method” and to display the totalization results as aforementioned.

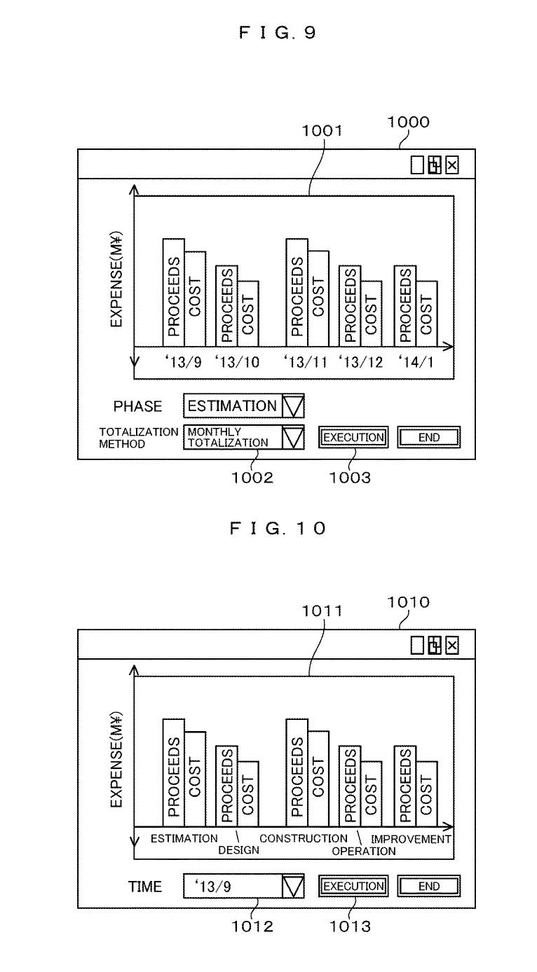

FIG. 10 is an illustration showing an example of the profit totalizing screen 1010. In the displayed items 1001, the horizontal axis represents “Phase” and the vertical axis represents “Expense”, wherein proceeds and costs totalized on the phase basis are shown in the form of a column graph.

The distribution warehouse profitability evaluation unit 1111 receives the choice of “Time” from the user through an input item 1012. In the example shown in FIG. 10, when the use chooses “‘13/9” as “Time” and then depresses a bottom for an input item “Execution” 1013, the distribution warehouse profitability evaluation unit 1111 receives the input, re-totalizes respective phases on the inputted “time” basis and executes the display as aforementioned. In the example of FIG. 10, it is possible to compare proceeds and costs in each “Phase” as of the day of “‘13/9”. Although FIG. 10 displays “‘13/9” taken as an example, it is also possible to choose another time and executes a display as aforementioned.

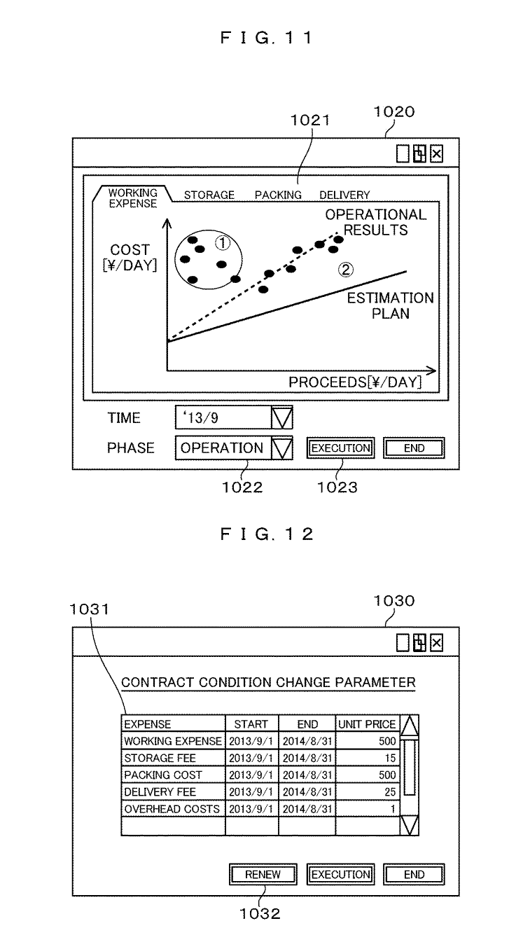

Next, the profit description deviation diagnosis unit 1112 diagnoses and specifies a description of the deviation in the profit evaluation (S20). The details of this step S20 will be described with reference to FIG. 11.

FIG. 11 is an illustration showing a profit evaluation screen 1020. The profit evaluation screen 1020 is a screen for showing the results from the profit description deviation diagnosis unit 1112. In the displayed items 1021, each of respective “Expense Item” tabs has the horizontal axis representing proceeds and the vertical axis representing costs, wherein a scatter diagram is shown with plotting made on the time basis and the phase basis.

The profit description deviation diagnosis unit 1112 receives choices of “Time” and “Phase” from the user through input items 1022. In the example of FIG. 11, when the user chooses “‘13/9” as “Time” and chooses “Operation” as “Phase” and then depresses a bottom for an input item “Execution” 1023, the profit description deviation diagnosis unit 1112 receives the inputs, executes a retotalization in terms of “Operation” as of the day of “‘13/9” and performs a display as aforementioned. In the example of FIG. 11, it becomes possible to diagnose “Working Expense”. In the example of FIG. 11, another “Expense Item” such as “Storage”, “Packing”, “Delivery” or the like can be chosen and displayed in the same manner as aforementioned.

By this figure, it becomes realized to visualize (A) the diagnosis of factors on the day on which costs rise (working contents and factors therefor) and (B) the clarification of actual works which are considerable in deviation from those of an original plan.

Further, the profit description deviation diagnosis unit 1112 automatically totalizes the aforementioned (A) and (B) and calculates the degree at which actual results deviate from the original plan, to specify the factors.

Next, the contract condition change scenario registration unit 1113 registers a contract condition change scenario in the contract condition change information storage unit 1153 in response to the description of the deviation (S30). The details of this step S30 will be described with reference to FIG. 12.

FIG. 12 is a contract condition change screen 1030. The contract condition change screen 1030 shows the calculation results of the contract condition change scenario registration unit 1113. In the input items 1031, details are displayed that have been read in the contract condition change information storage unit 1153. Incidentally, designated (original) contract conditions are registered therein as initial values.

The contract condition change scenario registration unit 1113 receives changes of contract conditions from the user through the input items 1032. In the example of FIG. 12, when the user inputs parameters for changing the contract conditions to the input items 1031 and then depresses a bottom for an input item “Renew” 1032, the contract condition change scenario registration unit 1113 renews details in the contract condition change information storage unit 1153.

Further, when the user depresses a bottom for an input item “Execution” 1032, the profit calculation simulation execution unit 1114 executes a profit calculation simulation for the distribution warehouse based on the details in the contract condition change information storage unit 1153 and registers simulation results in the simulation result storage unit 1154 (S40).

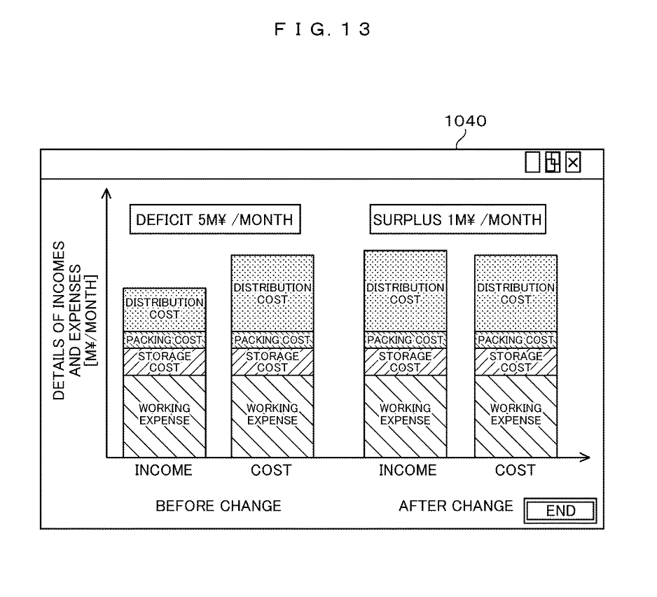

Finally, the simulation result output unit 1115 outputs the simulation results registered in the simulation result storage unit 1154 (S50). FIG. 13 is an output screen showing the results of the profit calculation simulation. The output screen 1030 displays calculation results of incomes and expenses, which results are the calculation results of the profit calculation simulation execution unit 1114, in terms of each “Expense Item” in the form of a column graph, so that visualization can be attained to enable the user to make comparisons. Those data before and after the change are displayed respectively on the left and right on the present screen, so that it becomes possible to evaluate the influence of the change in the contract conditions.

### REFERENCE SIGNS LIST

110 Warehouse profit simulation device
111 Control section
112 Input section
113 Output section
114 Communication section
115 Storage unit
190 Network
1111 Distribution warehouse profitability evaluation unit
1112 Profit description deviation diagnosis unit
1113 Contract condition change scenario registration unit
1114 Profit calculation simulation execution unit
1115 Simulation result output unit
1151 Warehouse proceeds information storage unit
1152 Warehouse cost information storage unit
1153 Contract condition change information storage unit
1154 Simulation result storage unit

1. A warehouse profit simulation device comprising:
an information storage unit for storing data relating to incomes and expenses in respective phases from estimation to operation of a distribution warehouse as historical data in a unitary manner;
a profit description deviation diagnosis unit for reading out the historical data from the information storage unit and for diagnosing factors causing a deviation between estimated amounts and the subsequent balance of payment to specify a description of the deviation;
a contract condition change scenario registration unit for creating a contract condition change scenario in response to the specified description of the deviation and registering the scenario in the information storage unit; and
a profit calculation simulation execution unit for executing a profit calculation simulation of the distribution warehouse under the registered contract condition change scenario.

2. The warehouse profit simulation device according to claim 1, further comprising:
a designated contract conditions changing unit; and
a profit evaluation unit for executing a profit calculation simulation under the changed contract conditions changed by the designated contract conditions changing unit and evaluating the profit.

3. The house profit simulation device according to claim 2, wherein:
a plan for balance of payment under the designated contract conditions and a plan for balance of payment under the changed contract conditions are visualized for a user to make comparisons.

4. A warehouse profit simulation method comprising:
storing data relating to incomes and expenses in respective phases from estimation to operation of a distribution warehouse as historical data in a unitary manner;
reading out the historical data from the information storage unit and diagnosing factors causing a deviation between estimated amounts and the subsequent balance of payment to specify a description of the deviation;
creating a contract condition change scenario in response to the specified description of the deviation; and
executing a profit calculation simulation for the distribution warehouse under the contract condition change scenario.

5. The warehouse profit simulation method according to claim 4, further comprising:
changing designated contract conditions and executing a profit calculation simulation under the changed contract conditions to evaluate the profit.

6. The warehouse profit simulation method according to claim 5, further comprising:
visualizing a plan for balance of payment under the designated contract conditions and a plan for balance of payment under the changed contract conditions for enabling a user to make comparisons.
